(19) United States
(12) Patent Application Publication
(10) Pub. No.: US 2024/0200768 A1
(43) Pub. Date: Jun. 20, 2024

(54) RING-TYPE LIGHTING DEVICE

(71) Applicant: KOWA COMPANY, LTD., Nagoya-shi (JP)

(72) Inventors: Kentaro KANEKO, Soka-shi (JP); Takayuki FUJIOKA, Soka-shi (JP)

(21) Appl. No.: 18/287,210

(22) PCT Filed: Mar. 8, 2022
(86) PCT No.: PCT/JP2022/009876

§ 371 Date: Oct. 17, 2023

(30) Foreign Application Priority Data
Apr. 22, 2021 (JP) 2021-072918

(51) Int. Cl. F21V 31/00; F21V 17/12; F21V 17/16; F21Y 105/18; F21Y 115/10

(52) U.S. Cl. CPC F21V 31/005; F21V 17/12; F21V 17/16; F21Y 2105/18; F21Y 2115/10

(57) ABSTRACT

Ring-type lighting device of the present invention comprises: a case member having an annular shape and comprising an inner wall portion and an outer wall portion, the inner wall portion defining a hollow portion at a center, the outer wall portion defining an opening portion that has an annular shape and surrounds the hollow portion; one or more LED members provided to face an opening of the opening portion; and a cover member that has an annular shape and is provided between the opening and the LED members to close the opening portion. Such a ring-type lighting device is easy to assemble and is reduced in size while having waterproof properties.

### TECHNICAL FIELD

The present invention relates to a ring-type lighting device.

### BACKGROUND ART

Lighting devices are used in various scenes and may be required to have waterproof and dustproof properties depending on the application. For example, the lighting device described in Patent Document 1 is waterproof and is used as a downlight, a spotlight, or the like used outdoors. In the lighting device described in Patent Document 1, a sealing member is provided to seal the circuit board side so that water does not enter.

### PRIOR ART DOCUMENTS

### Patent Documents

[Patent Document 1] JP2019-121497A

### SUMMARY OF THE INVENTION

### Problems to be Solved by the Invention

Meanwhile in the lighting devices and the like used in factory automation (FA) processes of factory production lines, the lighting devices are required not only to have high waterproof and dustproof properties even through they are not for outdoor use, but also to be reduced in size because the installation space may be limited. Unfortunately, however, if a glass plate serving as the cover member covering the light source unit is to be screwed, the outer shape of the lighting device becomes large due to the provision of a space for screwing. Moreover, the screws have to be spaced apart from the light-emitting axes of LEDs in the circumferential direction so as not to interfere with the paths of light emitted from the LEDs, and a large space for screwing is required, so there is a problem in that it is difficult to reduce the size. Furthermore, if the cover member is fixed with screws, it will take time and effort to assemble, which may be problematic.

The present invention has been made in view of such actual circumstances, and an object of the present invention is to provide a ring-type lighting device that is easy to assemble and is reduced in size while having waterproof properties.

### Means for Solving the Problems

To achieve the above object, first, the present invention provides a ring-type lighting device comprising: a case member having an annular shape and comprising an inner wall portion and an outer wall portion, the inner wall portion defining a hollow portion at a center, the outer wall portion defining an opening portion that has an annular shape and surrounds the hollow portion; one or more LED members provided to face an opening of the opening portion; and a cover member that has an annular shape and is provided between the opening and the LED members to close the opening portion, wherein the case member is formed with a mounting portion on which a circumferential edge portion of the cover member is mounted and held, an elastic member having an annular shape is provided between the mounting portion and the cover member, a pressing member is provided to press the circumferential edge portion of the cover member from the opening portion side, and the pressing member is engaged with and fixed to the case member (Invention 1).

According to the above invention (Invention 1), the pressing member is engaged with the case member to press the circumferential edge portion of the cover member, thereby pressing and elastically deforming the elastic member while fixing the cover member, and a structure having enhanced waterproof properties can be achieved. It is therefore possible to provide a ring-type lighting device that is easy to assemble and is reduced in size while having waterproof properties.

In the above invention (Invention 1), another annular elastic member may be further provided between the pressing member and the cover member (Invention 2).

In the above invention (Invention 2), a plate-like member for reducing friction may be provided between the pressing member and the other annular elastic member (Invention 3).

In the above invention (Invention 1 to 3), the pressing member may have an annular shape and may be screwed and fixed to the case member (Invention 4).

In the above invention (Invention 1 to 4), preferably, the pressing member may comprise: an inner pressing member that has an annular shape and is provided on the inner wall portion to press the circumferential edge portion of the cover member; and an outer pressing member that has an annular shape and is provided on the outer wall portion to press the circumferential edge portion of the cover member, the inner pressing member may be screwed and fixed to a wall surface of either an inner circumferential surface or an outer circumferential surface of the inner wall portion, the outer pressing member may be screwed and fixed to a wall surface of either an inner circumferential surface or an outer circumferential surface of the outer wall portion, the mounting portion may comprise: an inner mounting portion on which a circumferential edge portion on an inner circumferential side of the cover member is placed; and an outer mounting portion on which a circumferential edge portion on an outer circumferential side of the cover member is placed, and the cover member may be placed on the inner mounting portion and the outer mounting portion via respective annular elastic members (Invention 5).

In the above invention (Invention 1 to 5), the elastic member may be a waterproof and dustproof rubber having a rectangular cross section (Invention 6).

### Advantageous Effect of the Invention

According to the present invention, it is possible to provide a ring-type lighting device that is easy to assemble and is reduced in size while having waterproof properties.

### BRIEF DESCRIPTION OF DRAWINGS

FIG. 1 is a perspective view of a ring-type lighting device according to a first embodiment of the present invention.

FIG. 2 is an exploded perspective view of the ring-type lighting device according to the first embodiment of the present invention.

FIG. 3 is a cross-sectional view of the ring-type lighting device according to the first embodiment of the present invention.

FIG. 4 is a cross-sectional view of a ring-type lighting device according to a second embodiment of the present invention.

### EMBODIMENTS FOR CARRYING OUT THE INVENTION

### First Embodiment

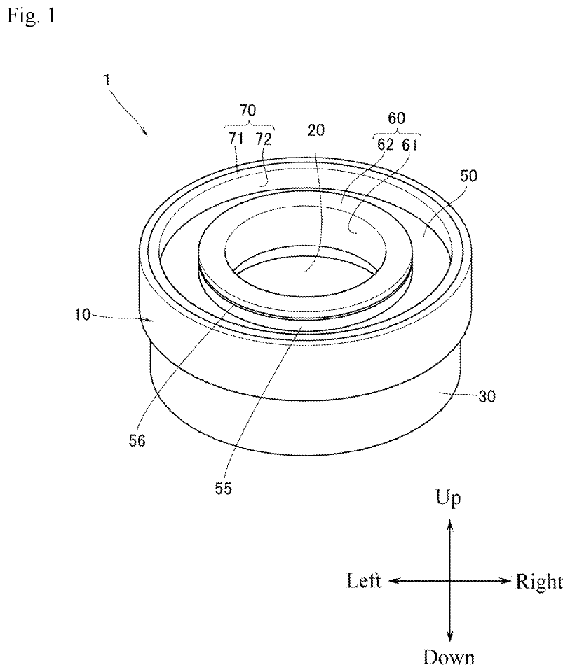

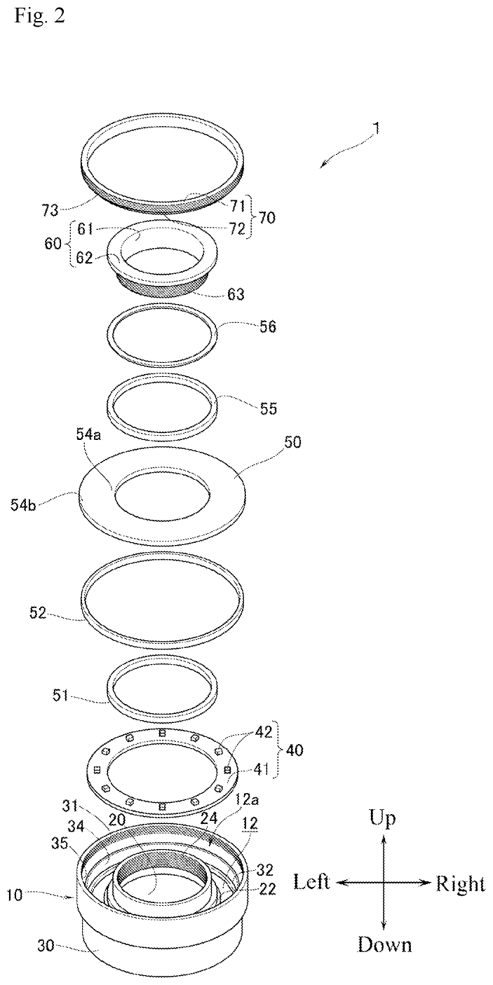

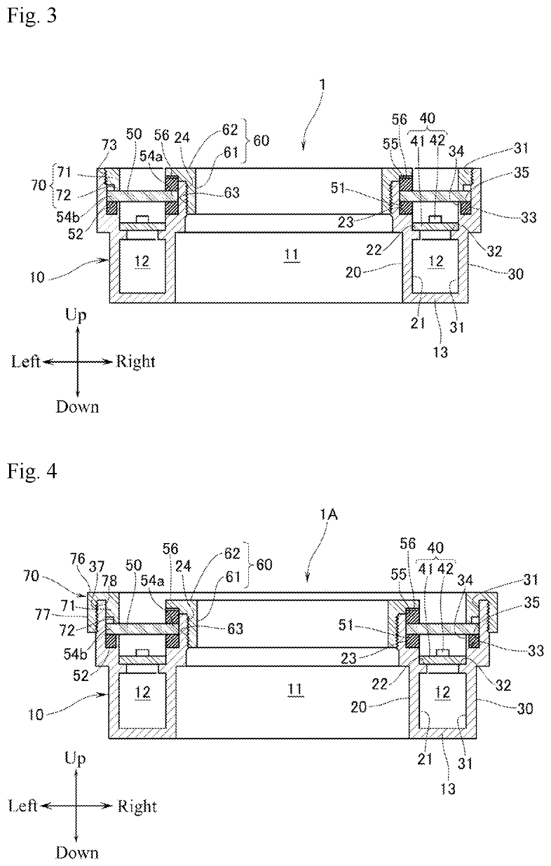

The first embodiment of the ring-type lighting device according to the present invention will be described with reference to FIGS. 1 to 3. Note that the up-down and right-left directions in each embodiment of the present invention correspond to those illustrated in the drawings.

A ring-type lighting device 1 includes a case member 10 having an annular shape. The case member 10 is formed with a hollow portion 11 in a central area around the axis of the case member 10. The case member 10 includes an inner wall portion 20 and an outer wall portion 30. The inner wall portion 20 defines the hollow portion 11. The outer wall portion 30 is spaced apart from the inner wall portion 20 in the radial direction and defines an opening portion 12 that has an annular shape and surrounds the hollow portion 11. The inner wall portion 20 and the outer wall portion 30 are formed to extend from a bottom wall portion 13 having an annular shape.

In the case member 10, an inner wall stepped portion for board 22 is formed along the entire circumference of an inner circumferential surface 21 of the inner wall portion 20. Likewise, an outer wall stepped portion for board 32 is formed along the entire circumference of an inner circumferential surface 31 of the outer wall portion 30. In the present embodiment, the inner circumferential surfaces 21 and 31 mean the surfaces of the inner wall portion 20 and the outer wall portion 30 facing each other, and the inner wall stepped portion for board 22 and the outer wall stepped portion for board 32 are also annular stepped portions provided to face each other. The inner wall stepped portion for board 22 and the outer wall stepped portion for board 32 are formed such that respective upper surfaces of the stepped portions are at the same height in the vertical direction (up-down direction).

An annular LED board 40 is placed on the inner wall stepped portion for board 22 and the outer wall stepped portion for board 32. The inner circumferential edge portion and outer circumferential edge portion of the LED board 40 are held by the inner wall stepped portion for board 22 and the outer wall stepped portion for board 32, respectively. In the present embodiment, the inner wall stepped portion for board 22 and the outer wall stepped portion for board 32 are provided as annular stepped portions that are continuous in the circumferential direction, but they may be discontinuously provided, for example, on the inner circumferential surfaces 21 and 31 because it is sufficient if they can hold the LED board 40. In another embodiment, the inner wall stepped portion for board 22 and the outer wall stepped portion for board 32 may be formed as one integrated stepped portion rather than separate portions. In this case, the one integrated stepped portion may be provided with one or more through-holes in which a power supply board, wiring, etc. can be inserted, which will be described later.

The LED board 40 is configured such that a plurality of LEDs 42 are mounted on one surface side of an annular board member 41. The LED board 40 is arranged such that the light emitting surfaces of the LEDs 42 face an opening 12a of the opening portion 12, that is, such that the light emitting surfaces face upward. The board member 41 of the LED board 40 is fixed, for example, by screws to at least one of the inner wall stepped portion for board 22 and the outer wall stepped portion for board 32. Any fixing method may be used, provided that it does not hinder the reduction in size of the ring-type lighting device 1.

The case member 10 houses inside a power supply board (not illustrated) on which a power supply circuit for driving the LEDs 42 mounted on the LED board 40 is mounted. The bottom wall portion 13 is formed with a power cable insertion hole (not illustrated). The case member 10 is thus configured such that the power cable can be inserted through the power cable insertion hole to supply power to the power supply board and input a control signal to control light emission of the LEDs 42. The power cable insertion hole may be provided anywhere in the case member 10, provided that it can be used for power supply and the like to the LED board 40.

The inner circumferential surface 21 of the inner wall portion 20 is formed with an inner wall stepped portion for glass 23 over the entire circumference of the inner circumferential surface 21 above the inner wall stepped portion for board 22. Likewise, the inner circumferential surface 31 of the outer wall portion 30 is formed with an outer wall stepped portion for glass 33 over the entire circumference of the inner circumferential surface 31 above the outer wall stepped portion for board 32. The circumferential edge end portion on the inner circumferential side of the outer wall stepped portion for glass 33 is provided with a wall portion 34 that extends to rise in the vertical direction in the figure, and a groove portion 35 is defined by the wall portion 34, the outer wall stepped portion for glass 33, and the outer wall portion 30. In the present embodiment, the wall portion 34 is continuously provided to extend in the circumferential direction on the circumferential edge end portion, but may be provided discontinuously in the circumferential direction.

The inner wall stepped portion for glass 23 and the outer wall stepped portion for glass 33 are formed so as to be at the same height in the vertical direction and are provided respectively with an inner rubber member 51 and an outer rubber member 52 that have a rectangular cross section and respective annular shapes. That is, the inner rubber member 51 has a smaller inner diameter than that of the outer rubber member 52. A glass plate 50 is placed on the inner wall stepped portion for glass 23 and the outer wall stepped portion for glass 33 via the inner rubber member 51 and the outer rubber member 52.

The glass plate 50 serves as a cover member for the case member 10. After closing the opening portion 12, the glass plate 50 gives waterproof properties to the ring-type lighting device 1 by being sealed with an inner pressing member 60, an outer pressing member 70, the inner rubber member 51, the outer rubber member 52, etc., as will be described later. The glass plate 50 has an annular shape when viewed from above. The glass plate 50 may be sufficient if it has at least light transmittance to such an extent that the light from the LEDs 42 can pass through. The glass plate 50 may be substituted with a plastic plate having diffuse transmittance/diffuse reflectance (such as an acrylic resin plate, an opaque polycarbonate resin plate, or a prism plate). Additionally or alternatively, various lenses or the like can be used as the cover member in order to control the light distribution.

An upper inner rubber member 55 is provided on the upper portion of a circumferential edge portion 54a on the inner circumferential side of the glass plate 50. The upper inner rubber member 55 is an elastic member having a rectangular cross-sectional view and having a height higher than the height of the case member 10 when placed on the glass plate 50 and can be pressed to elastically deform as will be described later.

A plate-like member 56 for reducing friction is provided between the upper inner rubber member 55 and the inner pressing member 60, which will be described later. The plate-like member 56 may be an annular member made, for example, of a resin such as PET (polyethylene terephthalate), POM (polyacetal), PC (polycarbonate), or fluorine resin and is provided to reduce friction between the upper inner rubber member 55 and the glass plate 50.

The ring-type lighting device 1 has the inner pressing member 60 provided on the inner wall portion 20 and the outer pressing member 70 provided on the outer wall portion 30 in the case member 10. The inner pressing member 60 and the outer pressing member 70 press circumferential edge portions 54 of the glass plate 50 thereby to press and elastically deform the inner rubber member 51, the outer rubber member 52, and the upper inner rubber member 55 while fixing the glass plate 50, thus enhancing the waterproof properties. Furthermore, the inner pressing member 60 and the outer pressing member 70 are screwed and fixed to the case member 10, so the assembly is easy.

The inner pressing member 60 and the outer pressing member 70 will be described in detail below.

The inner pressing member 60 is provided at the upper end of the inner wall portion 20 of the case member 10 and includes a cylindrical inner base portion 61 and a flange portion 62 provided at the upper end of the inner base portion 61. The inner pressing member 60 is configured such that the flange portion 62 covers the upper end of the inner wall portion 20 when viewed from above.

The inner base portion 61 has an outer circumferential surface 63 that is formed with a screw thread, and the inner wall portion 20 has an outer circumferential surface 24 (i.e., the surface on the hollow portion 11 side) that is formed with a thread groove corresponding to the scree thread. The inner pressing member 60 is fixed by being screwed (engaged) with the inner wall portion 20. When the inner pressing member 60 is fixed, the flange portion 62 presses the circumferential edge portion 54a (circumferential edge end portion) on the inner circumferential side of the glass plate 50 from above via the plate-like member 56 and the upper inner rubber member 55. This allows the glass plate 50 to be interposed and fixed between the upper inner rubber member 55 and the inner rubber member 51. In the present embodiment, the outer circumferential surface 63 of the inner base portion 61 is formed with the screw thread while the outer circumferential surface 24 of the inner wall portion 20 is formed with the thread groove, but the formation of the screw thread/thread groove may be reversed.

When the inner pressing member 60 is screwed to the inner wall portion 20, if the plate-like member 56 is not present, friction will occur between the inner pressing member 60 and the upper inner rubber member 55. As a result, force is also applied to the upper inner rubber member 55 in the rotational direction, so friction occurs also between the upper inner rubber member 55 and the glass plate 50. By providing the plate-like member 56 between the upper inner rubber member 55 and the inner pressing member 60, when the inner pressing member 60 is screwed to the inner wall portion 20, friction is less likely to occur between the inner pressing member 60 and the upper inner rubber member 55, and the assembling properties can therefore be improved.

The outer pressing member 70 includes a cylindrical outer base portion 71 and a pressing portion 72 that is formed continuously over the entire circumferential edge portion on the inner circumferential side of the lower end portion of the outer base portion 71. The pressing portion 72 is an annular wall portion that is formed to extend from the outer base portion 71 toward the glass plate 50 side.

The outer base portion 71 has an outer circumferential surface 73 that is formed with a screw thread, and the outer wall portion 30 has an inner circumferential surface 31 that is formed with a thread groove corresponding to the scree thread. The outer pressing member 70 is fixed by being screwed to the outer wall portion 30. When the outer pressing member 70 is fixed, the pressing portion 72 presses the glass plate 50 from above in a state of being contact with a circumferential edge portion 54b of the glass plate 50. This allows the glass plate 50 to be interposed and fixed between the wall portion 34 and the pressing portion 72 which faces the wall portion 34.

Thus, in the present embodiment, the assembly is easy because the inner pressing member 60 and the outer pressing member 70 are screwed and fixed to the case member 10 and the number of components is small. Moreover, by fixing the glass plate 50 using the inner pressing member 60 and the outer pressing member 70 which are thus screwed and fixed to the case member 10, it is not necessary to fix the glass plate 50 with screws or the like, and the reduction in size is possible. Furthermore, while the inner pressing member 60 and the outer pressing member 70 press and fix the annular glass plate 50, the pressing elastically deforms the inner rubber member 51, the upper inner rubber member 55, and the outer rubber member 52, and the sealing can thereby be readily achieved between the case member 10 and the glass plate 50. Thus, in the present embodiment, the ring-type lighting device 1 has waterproof and dustproof effects, is reduced in size, and can readily be assembled.

In addition, the outer rubber member 52 itself is pressed via the glass plate 50 and elastically deformed, and the outer rubber member 52 thereby serves not only as a means for sealing but also as a means for positioning and fixing the glass plate 50. Moreover, by interposing the glass plate 50 between the inner rubber member 51 and the upper inner rubber member 55, high pressure (distortion) is not applied to the glass plate 50, and the generation of stress in the glass plate 50 and its breakage are thereby prevented. In this case, it may be possible to further provide another annular rubber member on the circumferential edge portion 54b on the outer circumferential side of the glass plate 50. Fortunately, however, in the case of the ring-type lighting device 1 illustrated in the present embodiment, the waterproof properties can be ensured while sufficiently fixing the glass plate 50, and the number of components can be reduced as compared with the above case of providing another annular rubber member.

Furthermore, the pressing portion 72 may not be provided, and the outer base portion 71 may be configured such that its entire lower surface presses the circumferential edge portion 54b as a whole on the outer circumferential side of the glass plate 50, and in this case the pressing area increases thereby to allow the glass plate 50 to be fixed without generating unnecessary stress in the glass plate 50. On the other hand, by pressing only the position corresponding to the wall portion 34 with the pressing portion 72 as in the present embodiment, the pressing area can be reduced to increase the pressing force so that the glass plate 50 is more stably fixed, and the sealing performance can be enhanced to improve the waterproof properties. In this case, even when the pressing force is increased, the presence of the wall portion 34 below the glass plate 50 allows the glass plate 50 to be supported in a state in which the high pressing force is applied.

In addition, the outer rubber member 52 is disposed to be fitted in the groove portion 35 so as not to fall off when the outer pressing member 70 is screwed and fixed to the outer wall portion 30. Furthermore, since the pressing portion 72 is formed on the outer base portion 71 so as to face the wall portion 34, the pressing portion 72 and the outer wall portion 30 are separated so that a space is formed between them; therefore, even if a liquid enters, the liquid can be stored in this space, and the sealing performance is thus high. Moreover, since the wall portion 34 is formed to form the groove portion 35, even if a liquid enters, the liquid can be stored in the groove portion 35, and the sealing performance is thus high.

### Second Embodiment

The second embodiment of the present invention will next be described. As for a ring-type lighting device 1A according to the second embodiment of the present invention, the description of the same configuration as in the first embodiment will be omitted. The difference from the first embodiment is that a flange portion 76 and an extension portion 77 that further extends from the flange portion 76 are provided on the opposite side to the pressing portion 72 of the cylindrical outer base portion 71, that is, on the upper end side of the outer base portion 71. The flange portion 76 is configured to cover the upper end portion of the outer wall portion 30 while the extension portion 77 is configured to be along an outer circumferential surface 37 of the outer wall portion 30.

In the present embodiment, the extension portion 77 has an inner circumferential surface 78 that is formed with a screw thread, and the outer wall portion 30 has an outer circumferential surface 37 that is formed with a thread groove corresponding to the scree thread. The outer pressing member 70 is fixed by being screwed to the outer wall portion 30. Also in the present embodiment, when the outer pressing member 70 is fixed to the outer wall portion 30, the pressing portion 72 presses the glass plate 50 from above in a state of being contact with the circumferential edge portion 54b of the glass plate 50. This allows the glass plate 50 to be interposed and fixed between the wall portion 34 and the pressing portion 72 which faces the wall portion 34. Thus, also in the present embodiment, the ring-type lighting device 1A has waterproof and dustproof effects, is reduced in size, and can readily be assembled as in the first embodiment.

While the ring-type lighting device according to the present invention has been described above with reference to the drawings, the present invention is not limited to the above embodiments, and various modifications can be carried out.

For example, in each of the above-described embodiments, the inner pressing member 60 and the outer pressing member 70 are provided on the inner wall portion 20 and the outer wall portion 30, respectively, but the present invention is not limited to this. Only one of the inner wall portion 20 and the outer wall portion 30 may be provided with a pressing member, and the other wall portion may be configured to be sealed with a sealing material such as epoxy resin at the joint portion with the glass plate. That is, it may be sufficient if at least one of the inner wall portion 20 and the outer wall portion 30 is provided with a pressing member. Even with such a configuration, the ring-type lighting device can readily be assembled, can be reduced in its size, and can be highly waterproof.

Moreover, in each of the above-described embodiments, the inner pressing member 60 is provided so as to be screwed to the inner wall portion 20, but the method of fixing the inner pressing member 60 to the inner wall portion 20 is not limited to this. For example, an engaging portion having a hook shape, for example, may be provided on the lower end side of the inner base portion 61 of the inner pressing member 60 while a recess-shaped portion to be engaged may be provided on the outer circumferential surface 24 of the inner wall portion 20 on the hollow portion 11 side, and these may be engaged with each other to fix the inner pressing member 60 to the inner wall portion 20. Even with such a fixing method, it is possible to reduce the size while improving the waterproof properties.

In addition, in the above-described embodiments, the inner pressing member 60 is fixed such that the outer circumferential surface 63 of the inner base portion 61 and the outer circumferential surface 24 of the inner wall portion 20 are screwed (engaged), but the present invention is not limited to this. For example, the inner pressing member 60 may have an extension portion formed by extending the flange portion 62 of the inner base portion 61 further downward, and the extension portion may be formed so as to be screwed and fixed to an inner circumferential surface 23 of the inner wall portion 20 facing the extension portion. In this case, the extension portion may be configured to press the glass plate 50 directly or may also be configured to press the glass plate 50 via the upper inner rubber member 55.

Furthermore, in each of the above-described embodiments, the pressing portion 72 is formed over the entire inner circumferential side of the lower end portion of the outer base portion 71 and has a continuous ring shape when viewed from below, but the present invention is not limited to this, and the pressing portion 72 may be discontinuous.

In addition, in each of the above-described embodiments, the upper inner rubber member 55 is provided, but it may not be provided. In this case, the inner pressing member 60 may also be formed with a pressing portion, and the pressing portion may be configured to press the glass plate 50 directly.

In each of the above-described embodiments, the rubber member 51 is used as the elastic member, but the present invention is not limited to this, and an elastic member such as an air/liquid-impermeable closed-cell sponge or a metal gasket may be used. In the present embodiment, each rubber member has a rectangular cross section, but the cross section may have a circular, elliptical, or other shape.

In each of the above-described embodiments, an annular member composed of resin is used as the plate member 56 for reducing friction, but the present invention is not limited to this, and a member formed of a material that is less likely to cause friction with the inner pressing member 60 may be used, for example, a member formed of a metal such as SUS (stainless steel), aluminum, or brass.

### INDUSTRIAL APPLICABILITY

The ring-type lighting device of the present invention is suitably used as lighting for FA.

### DESCRIPTION OF REFERENCE NUMERALS

1, 1A Ring-type lighting device
10 Case member
11 Hollow portion
12 Opening portion
13 Bottom wall portion
20 Inner wall portion
21 Inner circumferential surface
22 Inner wall stepped portion for board
23 Inner wall stepped portion for glass
24 Outer circumferential surface
30 Outer wall portion
31 Inner circumferential surface
32 Outer wall stepped portion for board
33 Outer wall stepped portion for glass
34 Wall portion
35 Groove portion
37 Outer circumferential surface
40 LED board
41 Board member
50 Glass plate
51 Inner rubber member
52 Outer rubber member
54a Circumferential edge portion
54b Circumferential edge portion
55 Upper inner rubber member
56 Plate-like member
60 Inner pressing member
61 Inner base portion
62 Flange portion
63 Outer circumferential surface
70 Outer pressing member
71 Outer base portion
72 Pressing portion
73 Outer circumferential surface
76 Flange portion
77 Extension portion
78 Inner circumferential surface

1. A ring-type lighting device comprising:
a case member having an annular shape and comprising an inner wall portion and an outer wall portion, the inner wall portion defining a hollow portion at a center, the outer wall portion defining an opening portion that has an annular shape and surrounds the hollow portion;
one or more LED members provided to face an opening of the opening portion; and
a cover member that has an annular shape and is provided between the opening and the LED members to close the opening portion,
wherein the case member is formed with a mounting portion on which a circumferential edge portion of the cover member is mounted and held,
an elastic member having an annular shape is provided between the mounting portion and the cover member,
a pressing member is provided to press the circumferential edge portion of the cover member from the opening side, and
the pressing member is engaged with and fixed to the case member.

2. The ring-type lighting device according to claim 1, wherein another annular elastic member is further provided between the pressing member and the cover member.

3. The ring-type lighting device according to claim 1, wherein a plate-like member for reducing friction is provided between the pressing member and the other annular elastic member.

4. The ring-type lighting device according to claim 1, wherein the pressing member has an annular shape and is screwed and fixed to the case member.

5. The ring-type lighting device according claim 1, wherein the pressing member comprises:
an inner pressing member that has an annular shape and is provided on the inner wall portion to press the circumferential edge portion of the cover member; and
an outer pressing member that has an annular shape and is provided on the outer wall portion to press the circumferential edge portion of the cover member,
the inner pressing member is screwed and fixed to a wall surface of either an inner circumferential surface or an outer circumferential surface of the inner wall portion,
the outer pressing member is screwed and fixed to a wall surface of either an inner circumferential surface or an outer circumferential surface of the outer wall portion,
the mounting portion comprises:
an inner mounting portion on which a circumferential edge portion on an inner circumferential side of the cover member is placed; and
an outer mounting portion on which a circumferential edge portion on an outer circumferential side of the cover member is placed, and
the cover member is placed on the inner mounting portion and the outer mounting portion via respective annular elastic members.

6. The ring-type lighting device according to claim 1, wherein the elastic member is a waterproof and dustproof rubber having a rectangular cross section.
